(19) United States
(12) Patent Application Publication
(10) Pub. No.: US 2017/0258669 A1
(43) Pub. Date: Sep. 14, 2017

(54) MASSAGE MECHANISM AND LEGLESS CHAIR-TYPE MASSAGE MACHINE INCLUDING THIS MASSAGE MECHANISM

(71) Applicant: DAITO ELECTRIC MACHINE INDUSTRY COMPANY LIMITED, Higashi-Osaka-shi, Osaka (JP)

(72) Inventors: Tetsuya ISHIKAWA, Higashi-Osaka-shi (JP); Zhenhai ZHANG, Higashi-Osaka-shi (JP); Shinsaku SHIMIZU, Higashi-Osaka-shi (JP)

(73) Assignee: DAITO ELECTRIC MACHINE INDUSTRY COMPANY LIMITED, Higashi-Osaka-shi, Osaka (JP)

(21) Appl. No.: 15/308,406

(22) PCT Filed: Apr. 13, 2016
(86) PCT No.: PCT/JP2016/061909

§ 371 Date: Nov. 2, 2016

(30) Foreign Application Priority Data
Jun. 24, 2015 (JP) 2015-126142

(51) Int. Cl. A61H 7/00

(52) U.S. Cl. CPC A61H 7/007; A61H 2201/1215; A61H 2203/0425

(57) ABSTRACT

To provide a legless chair-type massage machine autonomously keeping a standing state without falling rearward when placing on a floor surface while making a compact massage mechanism. A legless chair-type massage machine of the present invention includes: a rotating drive shaft for transferring rotating drive power to a massage member; a hoisting and lowering shaft for vertically moving a base; a first drive motor for driving the rotating drive shaft; and a second drive motor for driving the hoisting and lowering shaft, and further includes a massage mechanism having: the drive motors adjacently arranged left and right; motor rotating shafts oriented in the vertical direction; the rotating drive shaft provided in the front side of the motor rotating shafts; and the hoisting and lowering shaft provided in the rear side of the two motor rotating shafts, and a fall prevention mechanism is provided in a rear portion of a seat part for preventing a backrest part from falling down rearward.

### TECHNICAL FIELD

The present invention relates to a massage mechanism and a legless chair-type massage machine including this massage mechanism.

### BACKGROUND ART

Conventionally, a massage mechanism generates at least one or more massage operations of kneading, tapping, acupressure massage and vibration and applies a massage operation to a treatment region of a user.

As a massage mechanism (back kneading apparatus), there has been one disclosed in Patent Literature 1.

### CITATION LIST

### Patent Literature

Patent Literature 1: Japanese Unexamined Patent Publication JP-A2009-56019

### SUMMARY OF INVENTION

### Technical Problem

By the way, the massage mechanism disclosed in Patent Literature 1 is one built in a large size sofa chair, and in the case where this massage mechanism is built in a backrest part of a relatively small type and compact legless chair-type massage machine, a backrest part becomes a thick one in a back and forth direction.

If a backrest part becomes a thick one in a back and forth direction like this, for example, in spite of inclining the backrest part, an upper body of a user when leaning thereon becomes a slightly standing state by a thickness amount of the massage mechanism and it may includes a leaning comfort (seating comfort) of a user. That is, a legless chair-type massage machine including the massage mechanism disclosed in Patent Literature 1 becomes hard one to deal with.

Moreover, since the massage mechanism disclosed in Patent Literature 1 has a complicated and large sized device configuration, in the case where this is adopted to a relatively small type and compact legless chair-type massage machine, this legless chair-type massage machine becomes weigh and large type one to be problematic, and therefore it becomes impossible for a user to optionally move this to various places and receive a massage operation.

Furthermore, in the case where the above massage mechanism is built in a legless chair-type massage machine having a backrest part of a long size length in the vertical direction relative to a length in the back and forth direction of the seat, the backrest part becomes heavy by a weight amount of the massage mechanism with respect to a seat part, and therefore a center of gravity of the entire legless chair-type massage machine becomes high. If the backrest part, particularly, the upper side of the backrest part is heavy (center of gravity becomes high), when a user is not sitting on the seat part, i.e., when the legless chair-type massage machine is merely placed on a floor surface, it may compromised of falling down rearward and it becomes impossible for a user to easily sit on the seat part to be problematic.

Therefore, the present invention has been made in consideration of the above situation, having an object to provide a legless chair-type massage machine autonomously keeping a standing state without falling rearward when placing on a floor surface while making a compact massage mechanism.

### Solution to Problem

In order to accomplish the object mentioned above, the following technical means has been taken in the present invention.

A massage mechanism of the present invention includes: a first massage member provided on a base and having a first treating tip provided at a distal end for applying a massage operation from above to a treatment region of a user; a second massage member provided on the base and provided at a position facing the first treating tip, having a second treating tip provided at a distal end for applying a massage operation so as to be brought close to and separated away from the first treating tip; a rotating drive shaft provided on the base so as to be oriented in a left and right direction and transferring rotating drive power to the first massage member and the second massage member; a hoisting and lowering shaft provided on the base so as to be oriented in the left and right direction and transferring drive power for moving the base in a vertical direction; a first drive motor for rotating the rotating drive shaft to drive the first massage member and the second massage member; and a second drive motor for driving the first massage member while rotating the hoisting and lowering shaft to be moved in the vertical direction on the base, and it is characterized in that, the first drive motor and the second drive motor are adjacently arranged in the left and right direction, and the motor rotating shaft of the first drive motor and the motor rotating shaft of the second drive motor are provided so as to be oriented in the vertical direction, and that the rotating drive shaft is provided in a front side of the two motor rotating shafts and the hoisting and lowering shaft is provided in a rear side of the two motor rotating shafts.

Preferably, the second massage member is provided so that the second treating tip is positioned in a lower side of the rotating drive shaft, and the first drive motor and the second drive motor are provided in an upper side of the rotating drive shaft.

Preferably, the massage mechanism is configured to rotate the rotating drive shaft by the first drive motor and swing the first treating tip provided on the first massage member and the second treating tip provided on the second massage member in a manner of being brought close to and separated away from, thereby allowing to perform a gripping and kneading operation.

Preferably, the second drive motor is a double axle motor having two motor rotating shafts extending in the vertical direction, and the massage mechanism is configured to allow the first treating tip provided on the first massage member to perform a tapping operation by rotating power of one of the motor rotating shafts and rotate the hoisting and lowering shaft by rotating power of the other motor rotating shaft so as to be moved in the vertical direction on the base.

A legless chair-type massage machine of the present invention includes: the massage mechanism mentioned above; a seat part which can be placed on a floor surface and on which buttocks of a user can be seated; and a backrest part which is provided in a rear part of the seat part and which is provided supportably aback region of the user and in which the massage mechanism is built-in, and it is characterized in that a fall prevention mechanism is provided in a rear part of the seat part for preventing the backrest part from falling down rearward when the user does not seat.

Preferably, the fall prevention mechanism is provided so as to be freely retractably advancable rearward with respect to the seat part.

Preferably, the fall prevention mechanism includes a fall prevention member formed by bending a bar-shaped member in a U-character shape, and a region corresponding to an opening side of the U-character shape is slidably attached to the seat part.

Preferably, the seat part is configured to be foldable so as to be overlaid with respect to the backrest part.

### Advantageous Effects of Invention

According to the present invention, a size (particularly, thickness) of the massage mechanism can be made compact and it becomes possible to autonomously keep a standing state without falling rearward when placing the legless chair-type massage machine on a floor surface.

### BRIEF DESCRIPTION OF DRAWINGS

FIG. 1 is a perspective view showing an overall legless chair-type massage machine of the present invention (depicted while a front cover body being omitted).

FIG. 2 is a forward perspective view showing a massage mechanism of the present invention.

FIG. 3 is a front view of the massage mechanism (depicted while a base being omitted).

FIG. 4 is a right side view of the massage mechanism.

FIG. 5 is a bottom plan view of the massage mechanism (depicted while the base being omitted).

FIG. 6 is an enlarged view of a conversion part (depicted while two massage members being omitted).

FIG. 7 is a rearward perspective view of the legless chair-type massage machine and showing a state of a fall prevention member being extended out.

FIG. 8 is a perspective view of the legless chair-type massage machine when viewed from the bottom surface and showing a state of the fall prevention member being extended out.

FIG. 9 is a rearward perspective view of the legless chair-type massage machine and showing a state of the fall prevention member being stored.

FIG. 10 is a perspective view of the legless chair-type massage machine when viewed from the bottom surface and showing a state of the fall prevention member being stored.

FIG. 11 is a perspective view showing an accommodated state of the legless chair-type massage machine (depicted while the front cover body and a seat cove body being omitted).

### DESCRIPTION OF EMBODIMENTS

The following describes an embodiment of the present invention based on the drawings.

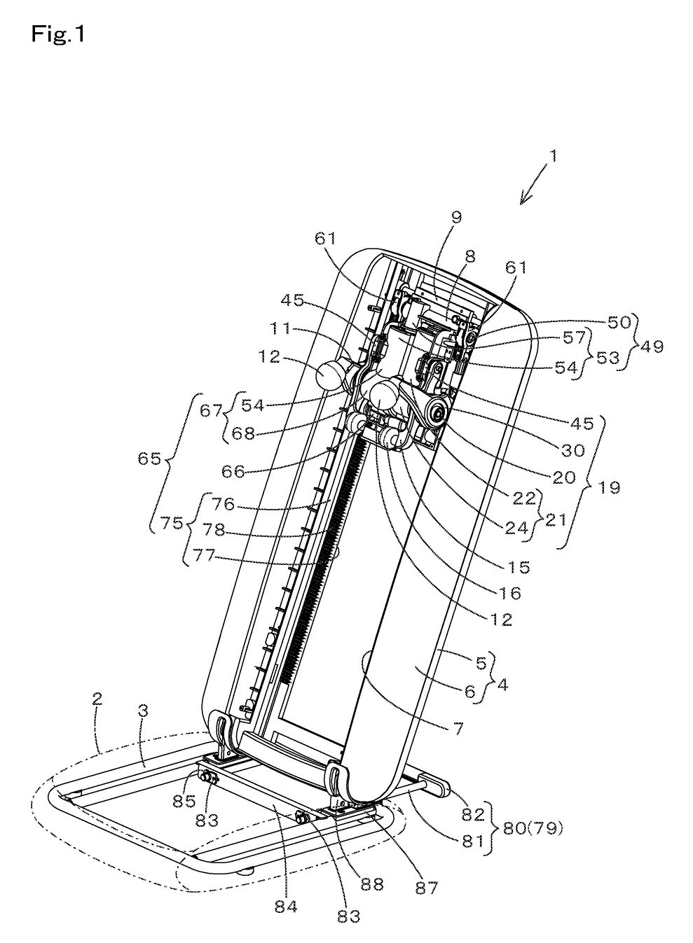

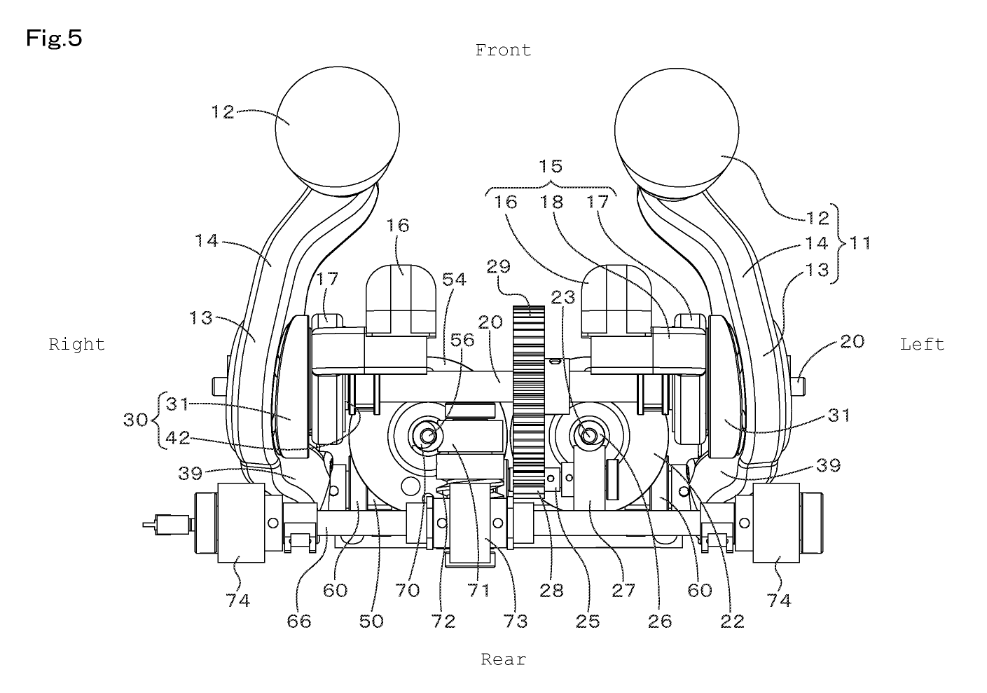

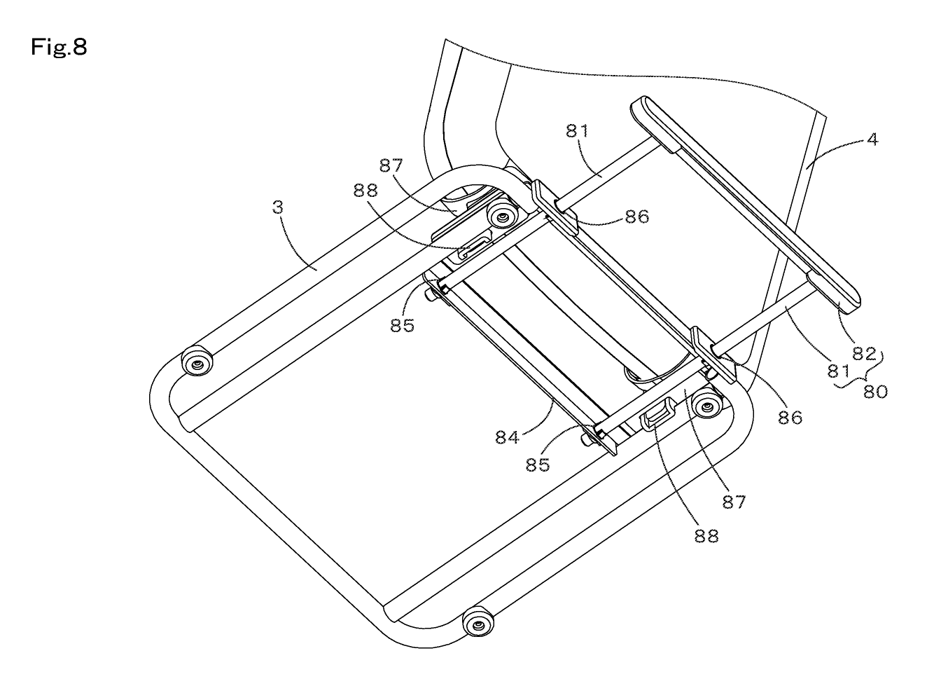

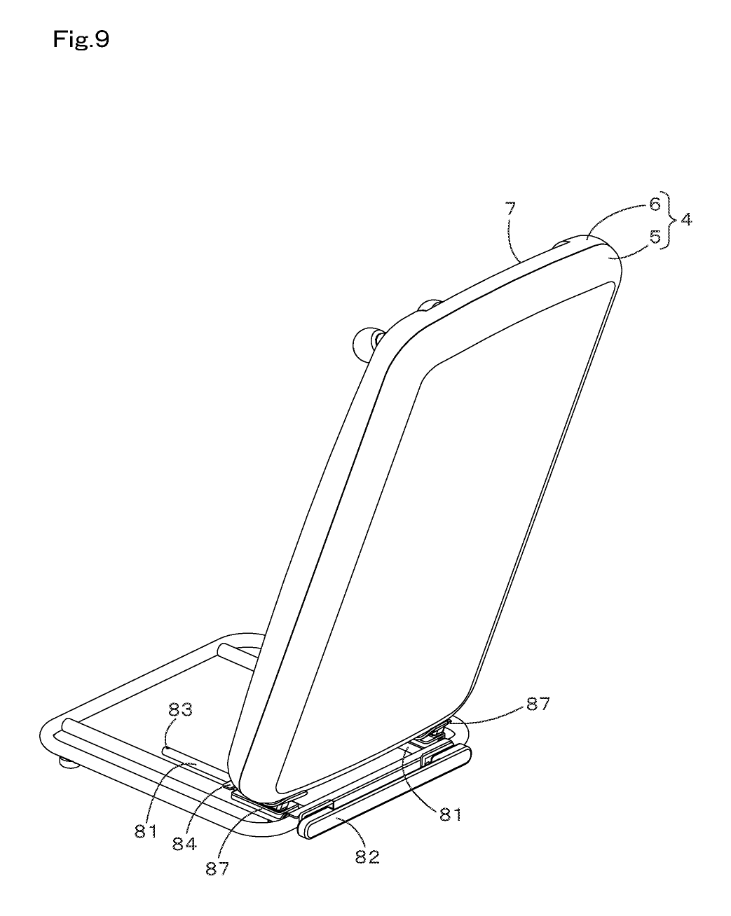

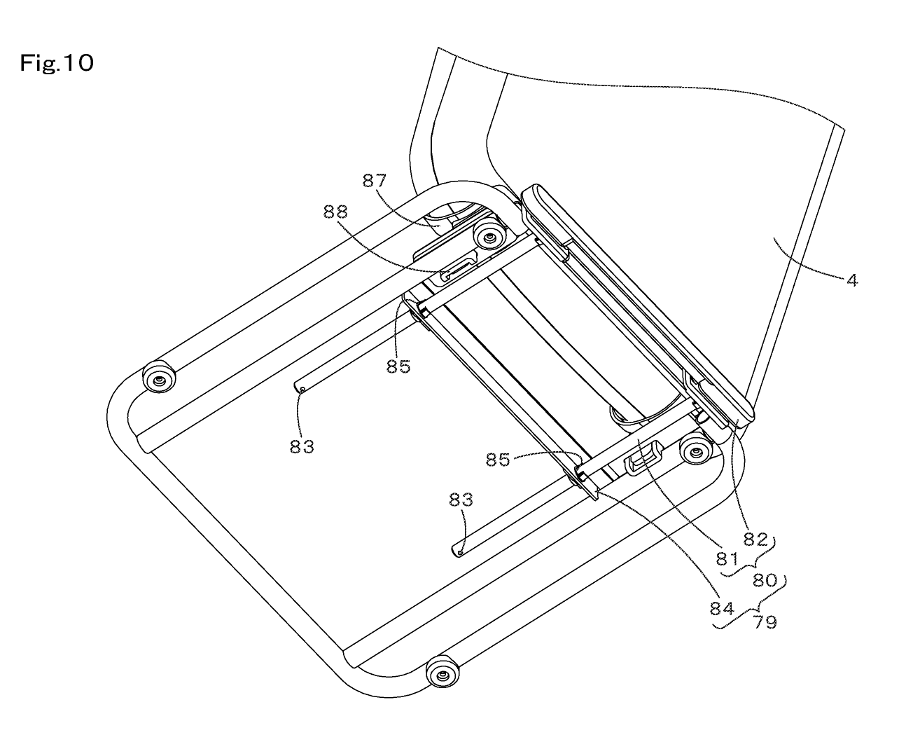

FIGS. 1 to 10 show embodiments of a massage mechanism 8 pertaining to the present invention and a legless chair-type massage machine 1 including this massage mechanism 8.

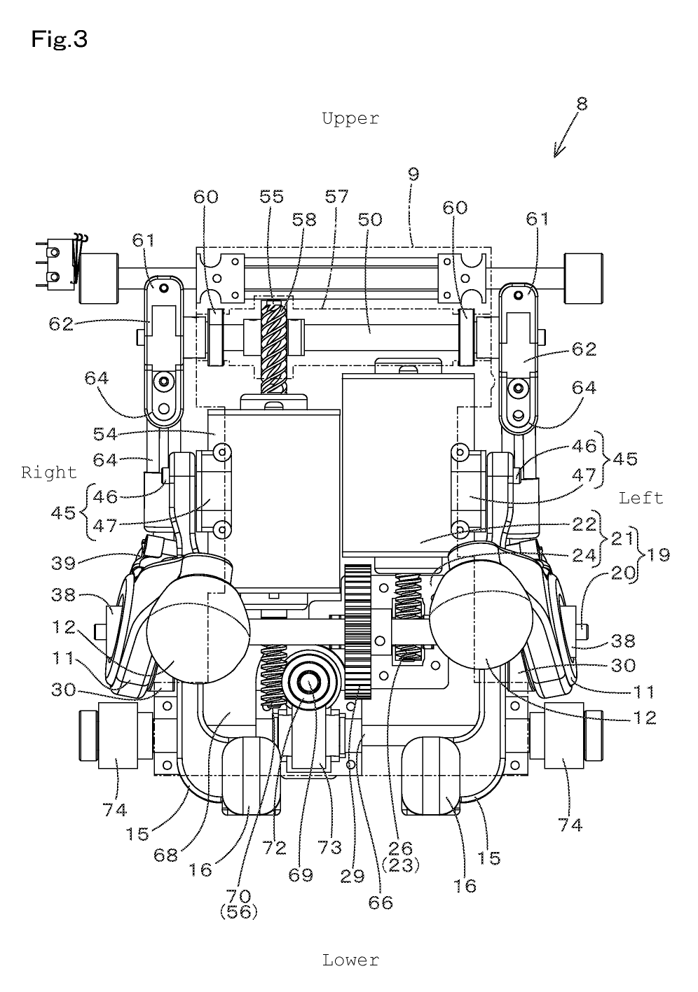

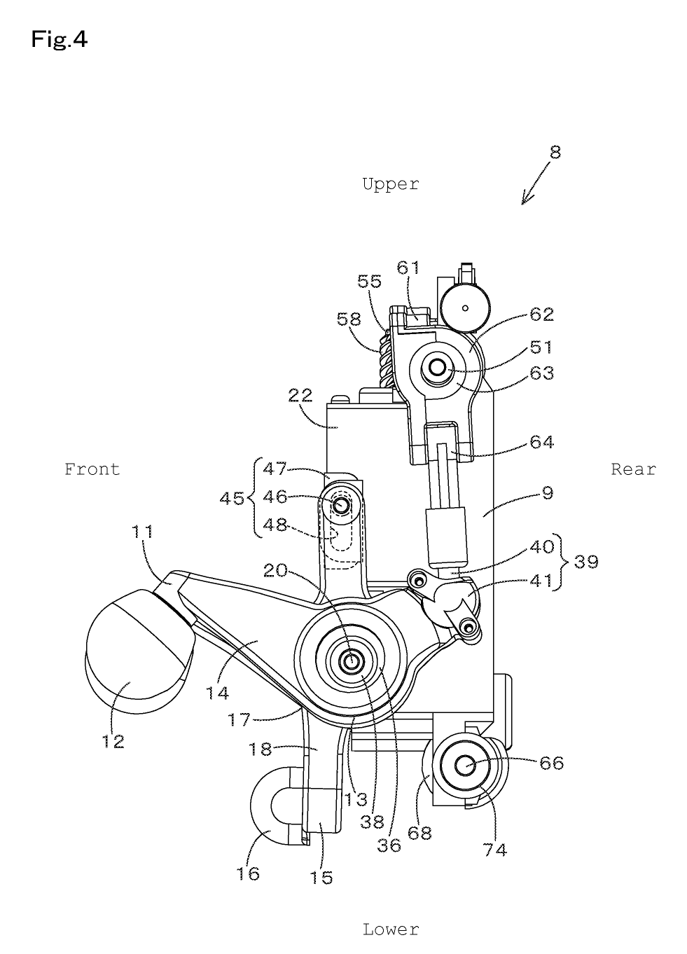

First, for convenience, in the following description, left and right directions in FIGS. 1 and 3 refer to “right and left direction” and “width direction” in the case of explaining the massage mechanism 8 and the legless chair-type massage machine 1 of the present embodiment. Further, a vertical direction in FIGS. 1 and 3 refers to a “vertical direction” in the case of explaining the massage mechanism 8 and the legless chair-type massage machine 1. Furthermore, a paper-surface penetrating direction oriented to a left oblique direction in FIG. 1 and a left and right direction in FIG. 4 refer to a “back and forth” direction in the case of explaining the massage mechanism 8 and the legless chair-type massage machine 1. These correspond to a back and forth direction, a left and right direction and a vertical direction when viewing from a user seated on the seat part 2 of the legless chair-type massage machine 1.

First, an outline of the legless chair-type massage machine 1 of the present embodiment is described.

As shown in FIG. 1, the legless chair-type massage machine 1 of the present embodiment includes: the seat part 2 which can be placed on a floor surface of such as a floor of a living and enable buttocks of a user to be seated thereon; a backrest part 4 which is provided in a rear portion of the seat part 2 and which is provided so as to be able to support a back region of a user; and a massage mechanism 8 which is built in the backrest part 4 and treats from a shoulder region to a lumbar region, i.e., treats for a back region, of a user seated on the seat part 2.

In addition, this legless chair-type massage machine 1 is allowed to be placed on a seat surface of a large-sized chair such as a sofa. That is, a floor surface on which the legless chair-type massage machine 1 is to be placed is not limited to a floor surface of such as a floor of a living room but includes a seat surface of a chair.

As shown in FIG. 1, the seat part 2 is a member formed in a substantially rectangular shape in plane view and a flame member 3 is provided inside thereof. Further, a cushion member (not shown) is provided on an upper surface (seat surface) side of the seat part 2. This seat part 2 is a member allowing buttocks of a user to be seated on the seat surface, that is, a plate shaped member having a sufficient wideness to support buttocks of a user from below, and it is placed on a floor surface so that the seat surface is oriented in a substantially horizontal direction. This seat part 2 is made to be able to give a comfortable seating feeling to a user.

The backrest part 4 is a member provided in the rear portion of the seat part 2 for supporting a back region (lumbar region to shoulder region) of a user and it is a housing (casing) having an inside thereof being a hollow. Further, the backrest part 4 has a length in the vertical direction which is a long size with respect to a length of the seat part 2 in the back and forth direction.

This backrest part 4 has a plate shape (plate shape) having a width slightly wider than a shoulder length of a user and having a long size in the vertical direction so as to be able to cover over an entire surface of a back region of a user, and it is formed using a material such as, for example, plastic material which is considered to be lighter in weight than metal.

Specifically, as shown in FIG. 1, the backrest part 4 has a thickness in the back and forth direction thinner compared to that in the width direction and has an appearance of a plate shape having a long size in the vertical direction, and it is intended to stand while being oriented in the back and forth direction when performing a massage operation. This backrest part 4 includes a base plate 5 (rear side plate) and a coated plate 6 (front side plate).

As shown in FIG. 1, the base plate 5 has a thin thickness in the back and forth direction, and it is formed to be forwardly opened and to be in a shallow recess shape. Onto the front surface of this base plate 5, there is attached the massage mechanism 8 including a vertical movement mechanism 65 which is rendered to freely move in the vertical direction on the front surface of the base plate 5 (inside the backrest part 4).

Meanwhile, the coated plate 6 has a thin thickness in the back and forth direction, and it is formed to have a long size in the vertical direction similarly to the base plate 5 and it is formed to be rearward opened and to be in a shallow recess shape. This coated plate 6 covers over an entire surface of the front surface of the base plate 5 with its opening side to be fit to the opening side of the base plate 5 to thereby close the forward opening of the base plate 5.

Further, an opening portion 7 is formed along a longitudinal direction (vertical direction) in a middle side in the width direction of the coated plate 6. In specific, this opening portion 7 has an opening width in the left and right direction wider than the width of the massage mechanism 8 and narrower than the width of the coated plate 6. Further, the opening portion 7 has an opening size in the vertical direction slightly smaller than the size of the coated plate 6 in the vertical direction. In other words, when viewed this opening portion 7 from the front, there is opened in a vertically long belt shape and the massage mechanism 8 is moved in the vertical direction along this vertically long opening portion 7.

Further, in the opening portion 7, a cloth-like front cover body (not shown) is provided for closing this opening portion 7 without a clearance. By this cloth-like front cover body, the massage mechanism 8 is prevented from directly abutting to a back region (treatment region) of a user.

In summary, the backrest part 4 is configured by overlapping the costed plate 6 and the base plate 5 in the back and forth direction, and a space is formed inside the overlaid portion, and the massage mechanism 8 is provided in the space.

Note that, the legless chair shape of the legless chair-type massage machine 1 described above is one example and it should not be limited to this shape.

The massage mechanism 8 of the present embodiment is a mechanism having two or more massage operations and it includes: a pair of massage bodies 10 which are provided with a predetermined space in the left and right direction; a tapping massage mechanism 49 for performing a tapping massage for a treatment region (back region) of a user; and a gripping and kneading massage mechanism 19 for performing a gripping and kneading massage. Furthermore, the massage mechanism 8 of the present embodiment includes the vertical movement mechanism 65 for guiding in the vertical direction within the backrest part 4.

A base 9 is a member for integrally accommodating the above described gripping and kneading massage mechanism 19, the tapping massage mechanism 49 and the vertical movement mechanism 65, and it is to be provided inside the backrest part 4 dividable back and forth, that is, provided on the front surface of the base plate 5. The base 9 includes: a first gear box 24 of a gripping and kneading drive unit 21 to be described later; a second gear box 57 of a tapping drive unit 53 and a third gear box 68 of the vertical movement mechanism 65.

Note that, although the massage mechanism 8 of the present embodiment is exemplified as including the two massage operations of the gripping and kneading massage mechanism 19 and the tapping massage mechanism 49, it may include at least two or more massage operations of kneading, tapping, figure pressure and vibration operations for aback region (treatment region) of a user.

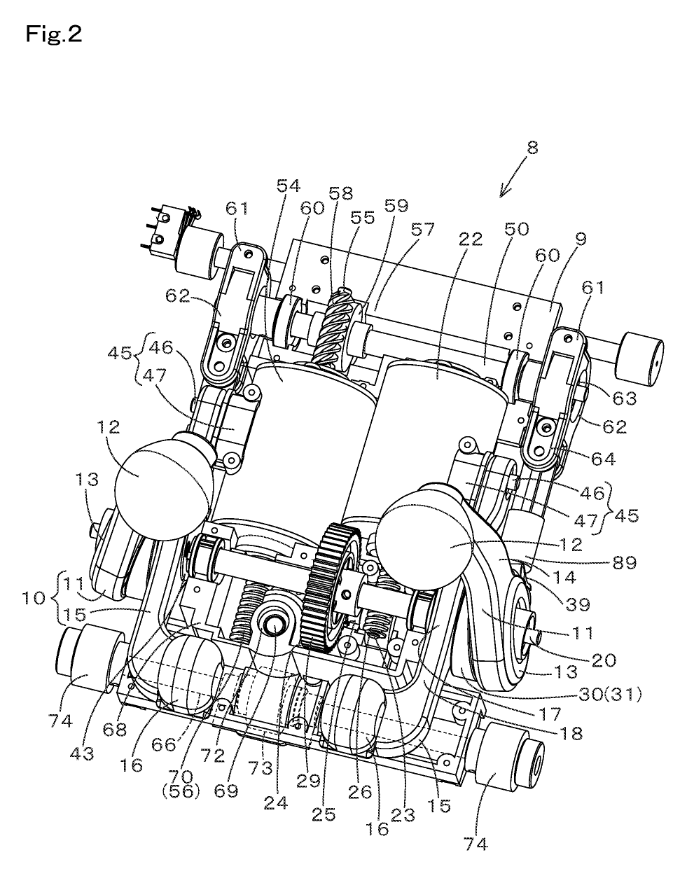

As shown in FIGS. 2 to 4, the massage body 10 is configure by combining, a first massage member 11 provided on the base 9 and having a first treating tip 12 provided at a distal end for applying a massage operation from above to a treatment region of a user, and a second massage member 15 provided on the base 9 and having a second treating tip 16 provided at a position facing the first treating tip 12 and provided at a distal end for applying a massage operation in a manner of being brought close to and separated away from the first treating tip 12, and the respective massage members are arranged so that the proximal ends thereof are overlaid.

The first massage member 11 (upper massage member) is a long size bar member which is positioned in an upper side of the second massage member 15 and provided so as to be protruded forward from a rotating drive shaft 20 of the gripping and kneading massage mechanism 19.

In the proximal end of the first massage member 11, a first annular fitting portion 13 is provided for fitting into a cam surface 32 of a tilt boss part 31 of a conversion part 30 to be described later via a bearing 36, and a support portion 14 (middle portion) is extended from the first annular fitting portion 13 toward the front side. The first annular fitting portion 13 is a thin thick ring shaped member and an inner peripheral diameter thereof is substantially the same as an outer peripheral diameter of the bearing 36 which is externally fitted to the cam surface 32 of the tilt boss part 31.

The first treating tip 12 is attached to the distal end of the first massage member 11 (support portion 14). The first treating tip 12 is formed in various shapes such as a spherical shape and is formed of such as resin or hard rubber.

The first treating tip 12 is attached so as to be further protruded from the opening portion 7 of the coated plate 6 in a front side of a rotating shaft center (shaft center of the rotating drive shaft 20) of the first annular fitting portion 13.

Meanwhile, at the proximal end of the first massage member 11, there is formed a first regulation piece 41 which constitutes a first regulation part 39 to be described later. This first regulation piece 41 is adapted so that a first regulation pin 40 formed at a distal end of a link member 61 constituting the first regulation part 39 is slidably fitted therein.

That is, while the first massage member 11 is oriented forward and upward, the first treating tip 12 at the distal end is oriented diagonally downward and is provided so as to be positioned in the front side of the rotating drive shaft 20.

Each of the second massage members 15 (lower massage members) is formed in a generally linear shape in a side view and it is provided so that the distal end, which each of the second treating tips 16 is attached to, is positioned in the lower side and is suspended by the rotating drive shaft 20 of the gripping and kneading massage mechanism 19.

In the middle portion of the second massage member 15, there is provided a second annular fitting portion 17 which is fitted into a cam surface 43 of an eccentric boss part 42 to be described later, and a support portion 18 is formed so as to be extended from the second annular fitting portion 17 downward. The second annular fitting portion 17 is a thin thick ring shaped member and an inner peripheral diameter thereof is substantially the same as the outer peripheral diameter of the cam surface 43 of the eccentric boss part 42.

The second treating tip 16 is attached to the distal end of the second massage member 15. The second treating tip 16 is formed in various shapes such as a thick disk type and spherical shape (semi-disk shape in the present embodiment) and it is formed of resin, hard rubber and the like.

The second treating tips 16 are provided so as to be positioned in the lower side of the rotating drive shaft 20 (for the gripping and kneading massage) to be described later. The second treating tips 16 are provided in positions facing the first drive motor 22 and a second drive motor 54 provided in the upper side of the rotating drive shaft 20 across the rotating drive shaft 20.

Further, each of the second treating tips 16 is attached so as to be further protruded from the opening portion 7 from the coated plate 6 in a lower side of a rotating shaft center (shaft center of the rotating drive shaft 20) of the second annular fitting portion 17.

Meanwhile, at the proximal end of each of the second massage members 15, there is formed a second regulation pin 46 of a column shape which constitutes a second regulation part 45 to be described later. This second regulation pin 46 is adapted so as to be slidably inserted to a regulation groove 48 (long hole) of a second regulation piece 47 constituting the second regulation part 45.

That is, the second massage member 15 is provided so that the second treating tip 16 is oriented forward and positioned in the lower side of the rotating drive shaft 20. Further, the second treating tip 16 is provided so as to face the first treating tip 12 each other across the rotating drive shaft 20. Therefore, a treatment region (shoulder region) of a user can be gripped in a manner of hitching.

In specific, the gripping and kneading massage mechanism 19 of the present embodiment is explained based on the drawings.

As shown in FIGS. 2 to 6, the gripping and kneading massage mechanism 19 of the present embodiment is provided so as to be oriented in the left and right direction on the base 9 inside the backrest part 4, and it includes: the rotating drive shaft 20 for transferring rotating drive power to the first massage member 11 and the second massage member 15; a gripping and kneading drive unit 21 for rotating the rotating drive shaft 20 and driving the first massage member 11 and the second massage member 15; and the conversion part 30 for converting the rotating power of the rotating drive shaft 20 to a gripping and kneading (swinging) movement.

The gripping and kneading massage mechanism 19 is configured that, the rotating drive shaft 20 is rotated by a first drive motor 22 (gripping and kneading drive motor) of the gripping and kneading drive unit 21, and the first treating tip 12 provided on the first massage member 11 and the second treating tip 16 provided on the second massage member 15 are swung so as to be brought close to and separated away from each other, thereby allowing to perform a gripping and kneading massage operation for a treatment region (shoulder region) of a user.

The rotating drive shaft 20 is provided in a manner of being bridged between the right side and the left side in the middle in the vertical direction of the massage mechanism 8 (base 9) and in the frontward of an output shaft (motor rotating shaft) 23 of the gripping and kneading drive motor 22. This rotating drive shaft 20 is provided so as to penetrate the first gear box 24 in the left and right direction and it is rotatably supported by the base 9 supporting the gripping and kneading massage mechanism 19.

At a generally middle of this rotating drive shaft 20, there is fitted a gear 29 for rotating the rotating drive shaft 20 and the gear 29 is engaged with a pinion gear 28 accommodated in the first gear box 24. Meanwhile, at both ends of the rotating drive shaft 20, there are provided a pair of conversion parts 30 (first massage member 11 and second massage member 15). The rotating drive shaft 20 has its shaft center provided in the front side of the output shaft 23 of the gripping and kneading drive motor 22 and a motor rotating shaft 55 of the second drive motor 54 (tapping drive motor) to be described later in a bottom side view.

The gripping and kneading drive unit 21 includes the gripping and kneading drive motor 22 and the first gear box 24 and these gripping and kneading drive motor 22 and first gear box 24 are provided on the base 9.

As shown in FIGS. 2 and 3, the gripping and kneading drive motor 22 (first drive motor) has its main body provided in a slightly upper side of the middle in the vertical direction and in the right side of the middle in the left and right direction in a front view and in the upper side facing the second treating tip 16 across the rotating drive shaft 20.

In addition, in the left side of the main body of the gripping and kneading drive motor 22, the tapping drive motor 54 (second drive motor) is adjacently arranged, and the gripping and kneading drive motor 22 is provided in the slightly upper side of the tapping drive motor 54. That is, the gripping and kneading drive motor 22 and the tapping drive motor 54 are provided in a position (offset position) shifted in the vertical direction in a front view.

Further, the gripping and kneading drive motor 22 is provided so that the output shaft 23 is oriented downward and positioned in the rear side of the rotating drive shaft 20. A worm gear 26 is attached to the distal end of this output shaft and the distal end thereof is inserted to the inside of the first gear box 24.

The first gear box 24 is provided in the lower side of the gripping and kneading drive motor 22, and inside thereof, there are accommodated: the worm gear 26; a rotating shaft 25 with its rotating shaft center oriented in the left and right direction; a worm wheel 27 with its rotating shaft center oriented in the left and right direction; the pinion gear 28; and the gear 29 for rotating the rotating drive shaft 20. These rotating shaft 25, worm wheel 27 and pinion gear 28 are provided in the rear side of the worm gear 26, and the gear 29 is provided in the front side of the worm gear 26.

The rotating shaft 25 is provided so as to be bridged over between the right side and the left side in a manner of penetrating the first gear box 24 in the left and right direction, and the worm wheel 27 is attached to the right side and the pinion gear 28 is attached to the left side. The worm gear 27 is engaged with the worm gear 26, and the pinion gear 28 is engaged with the gear 29 attached to the rotating drive shaft 20.

The gripping and kneading drive unit 21 transfers an output of the gripping and kneading drive motor 22 to the rotating drive shaft 20 via the worm gear 26; the worm wheel 27 and the pinion gear 28 which are co-rotated with the rotation of the rotating shaft 25; and the gear 29, in the first gear box 24, thereby operating the conversion part 30.

As shown in FIGS. 2 to 6, a pair of the conversion parts 30 are provided on both ends of the rotating drive shaft 20 and configured to convert the rotating drive power of this rotating drive shaft 20 to a swinging movement, thereby allowing the first treating tip 12 and the second treating tip 16 (a pair of massage members 11 and 15) to be brought close to and separated away from each other.

Each of the conversion parts 30 is attached in an inclined state with respect to the rotating drive shaft 20 and includes: the tilt boss part 31 having the cam surface 32 formed on an outer peripheral surface; the first annular fitting portion 13 provided at a proximal end of the first massage member 11 and fitted into the cam surface 32 of the tilt boss part 31; and the first regulation part 39 for regulating the first massage member 11 from pivoting accompanied with the rotation of the rotating drive shaft 20.

A pair of the tilt boss parts 31 are provided at both end portions of the rotating drive shaft 20 in the shaft center direction. Each of the tilt boss parts 31 is generally circular shaped inclined with respect to the rotating drive shaft 20 and has an endless track (cam surface 32).

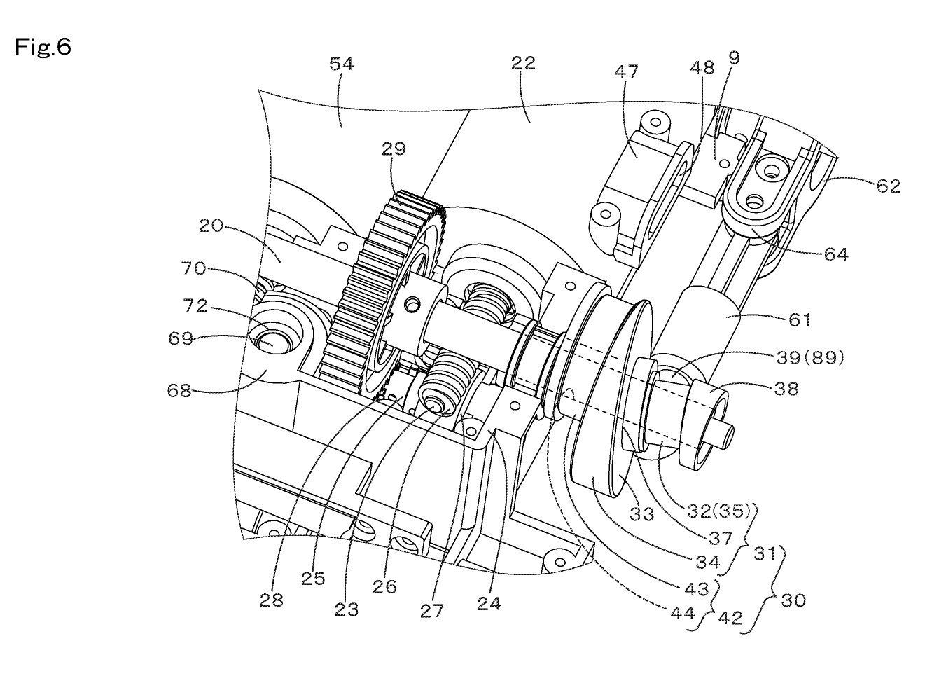

As shown in FIG. 6, the tilt boss part 31 is composed of: an inner cam member 34 having an end face 33 inclined with respect to the rotating drive shaft 20 and facing the eccentric boss part 42 in the left and right direction to be described later; and an outer cam member 35 having a generally column shape provided so as to protrude outward in the right and left direction from the inclined end face 33 of the inner cam member 34.

The cam surface 32 is formed on an outer peripheral surface adjacent to the inclined end face 33 of the inner cam member 34 and is provided so as to be inclined with respect to the shaft center of the rotating drive shaft 20. To this cam surface 32, the bearing 36 is slidably externally fitted. This tilt boss part 31 is fixed to the rotating drive shaft 20 so as not to be able to relatively rotate.

That is, the cam surface 32 of the tilt boss part 31 is provided so as to protrude outward in the right and left direction from the inclined end face 33 of the inner cam member 34, and it is thereby formed as an inclined face with respect to the rotating drive shaft 20.

This tilt boss part 31 is formed in a state that the inclined end face 33 of the inner cam member 34 and one end face 37 of the outer cam member 35 are abutted to be integral.

By the way, in the outside in the right and left direction of the tilt boss part 31, there are arranged a pair of regulation boss parts 38 in order to prevent the first massage member 11 from dropping out and the tilt boss part 31 from moving outward in the right and left direction. This regulation boss part 38 is also fixed to the rotating drive shaft 20 in order not to be able to rotate relatively to the rotating drive shaft 20.

The first annular fitting portion 13 is formed at the proximal end of the first massage member 11. This first annular fitting portion 13 is generally ring shaped in a side view and externally fits the bearing 36 fitted onto the cam surface 32 of the tilt boss part 31 and it is adapted to convert the rotation of the tilt boss part 31 to a swing movement in the right and left direction of the first massage member 11. Therefore, the tilt boss part 31 and the first annular fitting portion 13 are made freely pivotable relatively.

The first regulation part 39 includes: the first regulation pin 40 formed at a distal end of the link member 61 of the tapping massage mechanism 49 to be described later; and the first regulation piece 41 formed at the first annular fitting portion 13 (proximal end of the first massage member 11).

The first regulation pin 40 is a member formed in a spherical shape and it is adapted to be commonly used by a support part 89 of the link member 61 of the tapping massage mechanism 49 to be described later.

The first regulation piece 41 is a member formed so as to extend rearward from the rear side end portion of the first annular fitting portion 13. This first regulation piece 41 has its inside formed to be a hemispherical recess and its inner peripheral diameter is made substantially the same as the outer peripheral diameter of the first regulation pin 40.

That is, the first regulation part 39 is formed as a ball joint in which the spherical first regulation pin 40 formed at the distal end of the link member 61 is slidably fitted into the first regulation piece 41 formed as a hemispherical recess. In this way, by making the first regulation part 39 slidable, the first massage member 11 is regulated from pivoting about the rotating drive shaft 20, thereby allowing the first massage member 11 to perform a swing movement in the vertical direction.

Further, the conversion part 30 includes: the eccentric boss part 42 attached to the rotating drive shaft 20 in an eccentric state and having the cam surface 43 on the outer peripheral surface; the second annular fitting portion 17 provided at the proximal end of the second massage member 15 and fitted into the cam surface 43 of the eccentric boss part 42; and the second regulation part 45 for regulating the second massage member 15 from rotating accompanied with the rotation of the rotating drive shaft 20.

Meanwhile, a pair of the eccentric boss parts 42 are provided at both end portions in the shaft center direction of the rotating drive shaft 20 and each of them is arranged so as to be adjacent to the inner side in the right and left direction of the tilt boss part 31. The eccentric boss part 42 is formed in a flange shape and has a generally column shaped and endless track (cam surface 43) on the outer peripheral surface. Further, in the eccentric boss part 42, there is formed a through-hole 44 oriented in the right and left direction through which the rotating drive shaft 20 is inserted.

As shown in FIG. 6, the through-hole 44 is formed so that the shaft center is positioned differently with respect to a center axis (one-dotted chain line in FIG. 6) of the main body of the eccentric boss part 42. That is, although the shaft center of the through-hole 44 is oriented in the same direction as the shaft center of the rotating drive shaft 20, it is formed in the different position.

Therefore, regarding the eccentric boss part 42, since the center axis (shaft center of the through-hole 44) when rotating and the center axis of the main body are different, the eccentric boss part 42 rotates in a different track (a track so as to have a varying distance between the cam surface 43 and the center axis when rotating) with respect to the rotating track of the rotating drive shaft 20. That is, the eccentric boss part 42 eccentrically rotates with respect to the rotation of the rotating drive shaft 20. Note that the eccentric boss part 42 is fixed to the rotating drive shaft 20 so as not to be able to relatively rotate.

The cam surface 43 is oriented in a radially outward direction of the rotating drive shaft 20 and adapted to rotate about the rotating drive shaft 20. The second annular fitting portion 17 is slidably fitted to the cam surface 43 and the second massage member 15 is made freely swingable.

The second annular fitting portion 17 is formed at the proximal end of the second massage member 15. This second annular fitting portion 17 is formed in a ring shape in a side view having an inner peripheral diameter generally same as an outer peripheral diameter of the cam surface 43 of the eccentric boss part 42 and adapted to externally fit the cam surface 43 of the eccentric boss part 42 to thereby convert a rotation of the eccentric boss part 42 to a swing movement in the vertical direction of the second massage member 15. Therefore, the eccentric boss part 42 and the second annular fitting portion 17 are relatively pivotable freely.

Each of the second regulation parts 45 is composed of the second regulation pin 46 formed in the second annular fitting portion 17 (at a proximal end of the second massage member 15) and the second regulation piece 47 provided adjacently to the second regulation pin 46.

The second regulation pin 46 is made generally column shaped short sized bar piece and formed so as to protrude toward the inner side (motor side) in the width direction of the massage mechanism 8.

The second regulation piece 47 is provided in a position facing the second regulation pin 46 and adjacent to each of the drive motors 22 and 54, and it is attached to a motor cover (not shown) of the base 9. In this second regulation piece 47, there is formed a long hole regulation groove 48 along the vertical direction and the width thereof is generally the same as the diameter of the second regulation pin 46. The second regulation pin 46 is slidably fitted into the regulation groove 48.

That is, by sliding the second regulation pin 46 slidably fitted into the regulation groove 48 of the second regulation piece 47 along the regulation groove 48, the second regulation part 45 regulates the second massage member 15 from rotating about the rotating drive shaft 20 to thereby allow the second massage member 15 to perform a swing movement in the back and forth direction.

The massage mechanism 8 of the present embodiment is configured to rotate the gripping and kneading massage mechanism 19, i.e., the rotating drive shaft 20 by the rotating drive power of the output shaft 23 of the gripping and kneading drive motor 22 to thereby swing the first treating tip 12 provided on the first massage member 11 and the second treating tip 16 provided on the second massage member 15 so as to be brought close to and separated away from each other, thereby performing a gripping and kneading operation.

Next, the tapping massage mechanism 49 of the present embodiment is explained based on the drawings.

As shown in FIGS. 2 to 6, the tapping massage mechanism 49 of the present embodiment includes: a rotating drive shaft 50 provided on the base 9 inside the backrest part 4 and transferring the rotating drive power to the first massage member 11; the tapping drive unit 53 provided on the base 9 and accommodated in the left side of the gripping and kneading massage mechanism 19 in a front view and allowing the first massage member 11 to perform a tapping operation; and the link member 61 for transferring the power of the tapping drive unit 53 to the first massage member 11.

The tapping massage mechanism 49 is configured to rotate the rotating drive shaft 50 by the second drive motor 54 (tapping drive motor) of the tapping drive unit 53 and swing the first treating tip 12 attached to the first massage member 11 in the vertical direction, thereby allowing to perform a tapping massage operation for a treatment region (back region) of a user.

The rotating drive shaft 50 provided so as to be bridged over between the right side and the left side so as to penetrate the second gear box 57 in the left and right direction, and the shaft center is provided in a rear side of the shaft center of the rotating drive shaft 20 mentioned above (for a gripping and kneading massage operation).

To both ends of this rotating drive shaft 50, there are attached a pair of the eccentric cam members 51 each of which is formed in a flange shape and has a generally column shaped and endless track (cam surface) on the outer peripheral surface, and the cam surface (not shown) is externally fitted to a bearing 63 fitted into a third annular fitting portion 62 of the link member 61.

That is, the rotating drive shaft 50 is freely pivotably supported via the link member 61 and a bearing 63 and since the rotating shaft center of the eccentric cam member 51 is in an eccentric state with respect to the rotating shaft center of the bearing 63, the eccentric cam member 51 rotates in a track so as to have a varying distance between the cam surface and the center axis when rotating.

A worm wheel 59 is fitted to a slightly left side of a middle portion of the rotating drive shaft 50. This worm wheel 59 is engaged with a worm gear 58 provided on the output shaft 55 of the tapping drive motor 54 in a rear side of the rotating drive shaft 20.

The tapping drive unit 53 includes the tapping drive motor 54 (second drive motor) and the second gear box 57, and these tapping drive motor 54 and the second gear box 57 are accommodated in the base 9.

As shown in FIGS. 2 and 3, the main body of the tapping drive motor 54 is provided in the center in the vertical direction in a front view and in the left side of the center in the left and right direction, i.e., arranged in adjacent to the left side of the gripping and kneading drive motor 22. Further, the tapping drive motor 54 is provided in the upper side facing the second treating tip 16 across the rotating drive shaft 20 and it is provided so that an output shaft 56 is positioned in the rear side of the rotating drive shaft 20.

Note that, the tapping drive motor 54 of the present embodiment is a double axle motor having two motor rotating shafts (output shafts) 55 and 56 extending in the vertical direction, and one output shaft 55 is provided while being oriented in the upward direction and the other output shaft 56 is provided while being oriented in the downward direction. This tapping drive motor 54 rotates a hoisting and lowering shaft 66 of the vertical movement mechanism 65 to be described later to be moved in the vertical direction on the base 9 to thereby drive the first massage member 11.

The tapping drive motor 54 is provide in a position so that the shaft centers of the two output shafts 55 and 56 are oriented perpendicularly to the vertical direction including the shaft center of the output shaft 23 of the gripping and kneading drive motor 22 and on a plane parallel to the left and right direction. However, as shown in FIG. 3, since the main body of the tapping drive motor 54 and the main body of the gripping and kneading drive motor 22 are shifted in the vertical direction in arrangement, the other output shaft 56 of the tapping drive motor 54 and the output shaft 23 of the gripping and kneading drive motor 22 are shifted in the vertical direction in arrangement accompanied thereto.

The one output shaft 55 of the tapping drive motor 54 is provided so as to be oriented in the upward direction and the worm gear 58 is attached to the distal end and the distal end thereof is inserted to the inside of the second gear box 57.

The second gear box 57 is provided in the upper side of the main body of the tapping drive motor 54, and inside thereof, the worm gear 58, the worm wheel 59 having the rotating shaft center oriented in the left and right direction and the rotating drive shaft 50 are accommodated. The worm wheel 59 is provided in the rear side of the one output shaft 55 of the tapping drive motor 54 and engaged with the worm gear 58. Further, at each of both ends of the second gear box 57, a bearing 60 for freely pivotably supporting the rotating drive shaft 50 is provided.

The tapping drive part 53 transfers the output of the tapping drive motor 54 to the rotating drive shaft 50 via the worm gear 58 and the worm wheel 59 in the second gear box 57 to thereby swing a pair of the link members 61.

As shown in FIGS. 2 to 6, each of a pair of the link members 61 is adapted to convert the rotation of the tapping drive unit 53 to a tapping movement (movement in the vertical direction) to be transferred to the first massage member 11 and it is a bar shaped plate piece provided in a generally and vertically downward suspended state in a side view.

The distal end portion and the proximal end portion of each link member 61 are divided at a middle portion 64 in the vertical direction, and the distal end portion is pivoted in a manner of freely pivotable in the left and right direction with respect to the proximal end portion. With the shape like this, it is adapted to permit a swing movement in the left and right direction of the first annular fitting portion 13 (first massage member 11) externally fitted to the conversion part 30.

The third annular fitting portion 62 is provided at the proximal end portion of this link member 61. The third annular fitting portion 62 is a thinned link shaped member and externally fits the eccentric cam member 51 attached to the end portion of the rotating drive shaft 50 (for a tapping massage operation) via the bearing 63.

Meanwhile, at the distal end portion, the spherical first regulation pin 40 is formed and adapted to be slidably fitted into the hemispherical first regulation piece 41 (recess) provided in the first annular fitting portion 13.

That is, the link member 61 externally fits the eccentric cam member 51 at the proximal end portion via the bearing 63 and it is slidably coupled with first massage member 11 (first annular fitting portion 13) at the distal end portion, and therefore a clank movement becomes possible that the distal end portion moves in the vertical direction.

That is, by adapting this link member 61 as a clank mechanism, the first massage member 11 becomes to swing in the vertical direction, and by swinging of the first massage member 11, the first treating tip 12 swings in the vertical direction as well, thereby allowing to perform a tapping massage operation.

By the way, the tapping drive motor 54 causes the base 9 on which the first massage member 11 and the second massage member 15 and the like are provided, to move in the vertical direction by the rotating drive power of the other motor rotating shaft (output shaft) 56 arranged so as to be oriented in the downward direction.

Next, the vertical movement mechanism 65 of the present embodiment is explained based on the drawings.

As shown in FIGS. 1 to 5, the vertical movement mechanism 65 includes: the hoisting and lowering shaft 66 provided on the base 9 inside the backrest part 4 so as to be oriented in the left and right direction and transferring a hoisting and lowering operation in the vertical direction of the massage mechanism 8 (base 9); a hoisting and lowering drive unit 67 provided on the base 9 and accommodated in the lower side of the tapping massage mechanism 49 to move the massage mechanism 8; and a rail member 75 for guiding the massage mechanism 8 along the vertical direction.

The hoisting and lowering shaft 66 is adapted to move the massage mechanism 8 in the vertical direction by an output of the movement motor 54 and it is provided in the lower side of the massage mechanism 8 so that the shaft center is oriented in the left and right direction and provided in the rear side of the shaft center of the output shaft 23 of the movement motor 54 and the gripping and kneading drive motor 22.

A second worm wheel 73 is freely pivotably attached to a generally middle portion in the shaft center direction in the hoisting and lowering shaft 66, and the second worm wheel 73 is engaged with a second worm gear 72 provided in the upper side.

A pinion gear 74 is attached to each of the both ends of the hoisting and lowering shaft 66 and the pinion gear 74 is engaged with the rail member 75 provided on the base plate 5 in a manner of freely movable in the vertical direction. The pinion gear 74 rotates by a rotation of the hoisting and lowering shaft 66, and the massage mechanism 8 is thereby moved in the vertical direction along the rail member 75.

The hoisting and lowering drive unit 67 includes the movement motor 54 and the third gear box 68 and these movement motor 54 and third gear box 68 are accommodated in the base 9.

The movement motor of the present embodiment is the tapping drive motor 54 (second drive motor) mentioned above and is the double axle motor having the two output shafts 55 and 56 extending in the vertical direction. The movement motor 54 of the present embodiment causes the base 9 (massage mechanism 8) on which the first massage member 11 and the second massage member 15 and the like are provided to move in the vertical direction by rotating power of the output shaft 56 (the other output shaft of the second drive motor 54).

The movement motor 54 is provided in a position so that the output shaft 56 oriented in the downward direction and the shaft center of the output shaft 56 is oriented perpendicularly to the vertical direction including the shaft center of the output shaft 23 of the gripping and kneading drive motor 22 and on a plane in parallel to the left and right direction.

A first worm gear 70 is attached to the distal end of this output shaft 56 and the output shaft 56 is inserted to the inside of the third gear box 68.

As shown in FIGS. 2, 3 and 5, the third gear box 68 is provided in the lower side of the main body of the movement motor 54, and inside thereof, there are accommodated the first worm gear 70, a rotating shaft 69 having a shaft center oriented in the back and forth direction, a first worm wheel 71, the second worm gear 72, the second worm wheel 73, and the hoisting and lowering shaft 66 having a shaft center oriented in the left and right direction.

The rotating shaft 69 is provided so as to be bridged over between the front side and the rear side so as to penetrate the third gear box 68, having the first worm wheel 71 attached to the front side and second worm gear 72 attached to the rear side thereof. The first worm wheel 71 is engaged with the first worm gear 70, and the second worm gear 72 is engaged with the second worm wheel 73 attached to the hoisting and lowering shaft 66.

This hoisting and lowering drive unit 67 transfers the output of the movement motor 54 to the hoisting and lowering shaft 66 via the first worm gear 70, the first worm wheel 71 and the second worm gear 72 rotating together with the rotation of the rotating shaft 69, and the second worm wheel 73 in the third gear box 68.

Meanwhile, as shown in FIG. 1, the rail member 75 includes two side walls of a front side wall 76 and a rear side wall 77, and a pair of the rail members are provided at both ends in the left and right direction of the base plate 5. The front side wall 76 and the rear side wall 77 of the rail member 75 are provided so as to face in the back and forth direction, and the pinion gear 74 is inserted between the front side wall 76 and the rear side wall 77.

On the rear side wall 77 of the rail member 75, there is provided a rack gear 78 which is provided with rack teeth linearly aligned in series along the vertical direction. This rack gear 78 is engaged with the pinion gear 74 mentioned above to thereby convert the rotating power of the hoisting and lowering shaft 66 to a linear movement operation in the vertical direction.

That is, the vertical movement mechanism 65 of the present embodiment rotates the pinion gear 74 in the forward and reverse directions using the movement motor 54 to thereby move the massage mechanism 8 in the vertical direction along the rail member 75.

In this way, by providing the vertical movement mechanism 65 in the massage mechanism 8, the massage mechanism 8 is rendered to be freely movable in the vertical direction along the opening portion 7 of the backrest part 4. That is, this opening portion 7 extending in the vertical direction becomes “a movement area of the massage mechanism 8” in the present embodiment.

The massage mechanism 8 of the present embodiment is configured to allow the first treating tip 12 provided on the first massage member 11 to perform a tapping operation by the rotating power of the one output shaft 55 of the tapping massage mechanism 49, i.e., the tapping drive motor 54 and allow the hoisting and lowering shaft 66 of the vertical movement mechanism 65 to rotate by the rotating power of the other output shaft 56 to thereby move in the vertical direction on the base 9.

As described above, a specific feature of the massage mechanism 8 of the present embodiment resides in that, the main bodies of the gripping and kneading drive motor 22 (first drive motor) and the tapping drive motor 54 (second drive motor) are arranged side by side in the left and right direction and provided in adjacent positions, and each of the output shafts 23, 55 and 56 of the two drive motors 22 and 54 is oriented in the vertical direction and provided in the positions which are not shifted in the back and forth direction (non-offset positions). Further, in the present embodiment, it is also a specific feature that the rotating drive shaft 20 is provided in the front side of each of the output shafts 23, 55 and 56 of the two motors 22 and 54 and the hoisting and lowering shaft 66 is provided in the rear side of each of the output shafts 23, 55 and 56 of the two drive motors 22 and 54.

Furthermore, it is also a specific feature that the second treating tip 16 of the second massage member 15 is provided so as to be positioned in the lower side of the rotating drive shaft 20 and that the two drive motors are provided upper side of the rotating drive shaft 20.

In this way, regarding the massage mechanism 8, by providing the two drive motors 22 and 54 in adjacent arrangements so as to be in close contact in the left and right direction in a bottom plan view and providing in overlaid positions in a side plan view and by providing the second treating tip 16 and the two drive motors across the rotating drive shaft 20, the thickness in the back and forth direction in the massage mechanism 8 can be thinned and the height in the vertical direction can be lowered, and therefore a more compact mechanism can be made.

The massage mechanism 8 of the present embodiment is suitable for such as a legless chair-type massage machine 1 having a thin thickness in the back and forth direction in the backrest part 4.

By the way, in the legless chair-type massage machine 1 of the present embodiment, there is provided a fall prevention mechanism 79 in the rear side of the seat part 2 for preventing the backrest part 4 from falling down rearward when a user is not seating thereon.

The fall prevention mechanism 79 of the present embodiment includes a fall prevention member 80 formed by bending a bar shaped member in a U-character shape, and a guide member 84 for guiding the fall prevention member 80.

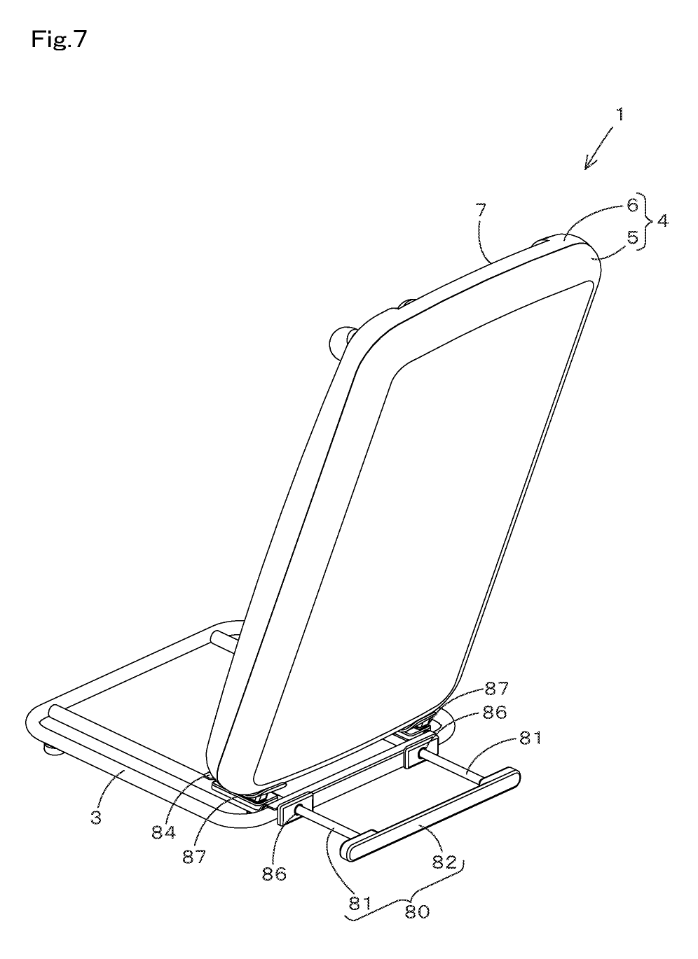

As shown in FIGS. 7 to 10, the fall prevention member 80 is provided so as to move in the back and forth direction inside the frame member 3 oriented in a generally horizontal direction when the seat part 2 is placed on such as a floor surface. In the fall prevention member 80, a region corresponding to an opening side of the U-character shape in the frame member 3 is slidably attached to the frame member 3 constituting the seat part 2.

The fall prevention member 80 includes: a pair of bar members 81 oriented in the back and forth direction of the seat part 2 and provided in the width (left and right) direction of the seat part 2; and a coupling member 82 for coupling the pair of bar members 81, and it is formed in a bent U-character shape in a plan view. Note that, in the present embodiment, the U-character shaped bent portion is used as a region coupling the bar member 81 and the coupling member 82.

The bar member 81 is a column shaped and long sized member and the length thereof is nearly half of the length in the back and forth direction of the seat part 2. Further, at a distal end of the bar member 81, there is formed a through-hole 83 and a short sized and column shaped pin (not shown) is inserted through the through-hole 83 and attached. This pin hooks with the guide member 84 to be described later when the fall prevention member 80 is drawn out, thereby preventing the fall prevention member 80 from dropping out to the rear side.

The coupling member 82 is a handle having a predetermined thickness, and a length in the longitudinal direction is the same distance as the space of the provided left and right one pair of the bar members 81 or a distance separated than the space. Further, the coupling member 82 is formed in a shape for a user to easily hold in order to make the fall prevention member 80 freely retractably advancable. Note that, in the present embodiment, the coupling member 82 is formed of a prism-shaped bar member 81 having a length of a distance fully separated than the space of the provided left and right one pair of the bar members 81.

Meanwhile, the guide member 84 is provided inside the seat part 2 so that the fall prevention member 80 may be made freely retractably advancable rearward with respect to the seat part 2.

This guide member 84 is provided by one generally at the center in the back and forth direction of the flame member 3 constituting the seat part 2 in order to be able to guide the fall prevention member 80. The guide member 84 is formed of along sized plate piece and it is attached so that the longitudinal direction is hooked over from the left side to the right side in the width direction of the flame member 3. At both ends of the guide member 84, there is formed a hole 85 one by one. That is, the guide member 84 is a long sized member formed in a generally eyeglass shape. The space between the two holes 85 is the same as the space of the two bar members 81 constituting the fall prevention member 80, and the inner peripheral diameter of the hole 85 is generally the same as the outer peripheral diameter of the bar member 81 constituting the fall prevention member 80.

Note that, also in a rear portion of the flame member 3, there are formed a pair of through-holes 86 with a space in the width direction same as space of the one pair of bar members 81 so that the bar members 81 can be inserted through and guided through the through-holes 86.

By making the space of the holes 85 formed in the guide member 84 same as the space of the bar members 81 and making the inner peripheral diameter of each hole 85 generally same as the outer peripheral diameter of each bar members 81, the fall prevention member 80 can be guided rearward of the seat part 2 and in the horizontal direction.

As described above, as a specific feature of the legless chair-type massage machine 1 of the present embodiment, it resides in that the fall prevention member 80 is provided in the rear portion of the seat part 2 for preventing the backrest part 4 from falling down rearward when a user does not seat (before seating) and that the fall prevention member 80 is made freely retractably advancable rearward with respect to the seat part 2.

In this way, by providing the fall prevention mechanism 79 freely retractably advancable rearward in the rear portion of the seat part 2, it becomes possible to autonomously keep a standing state without falling rearward when placing the seat part 2 of the legless chair-type massage machine 1 on a floor surface.

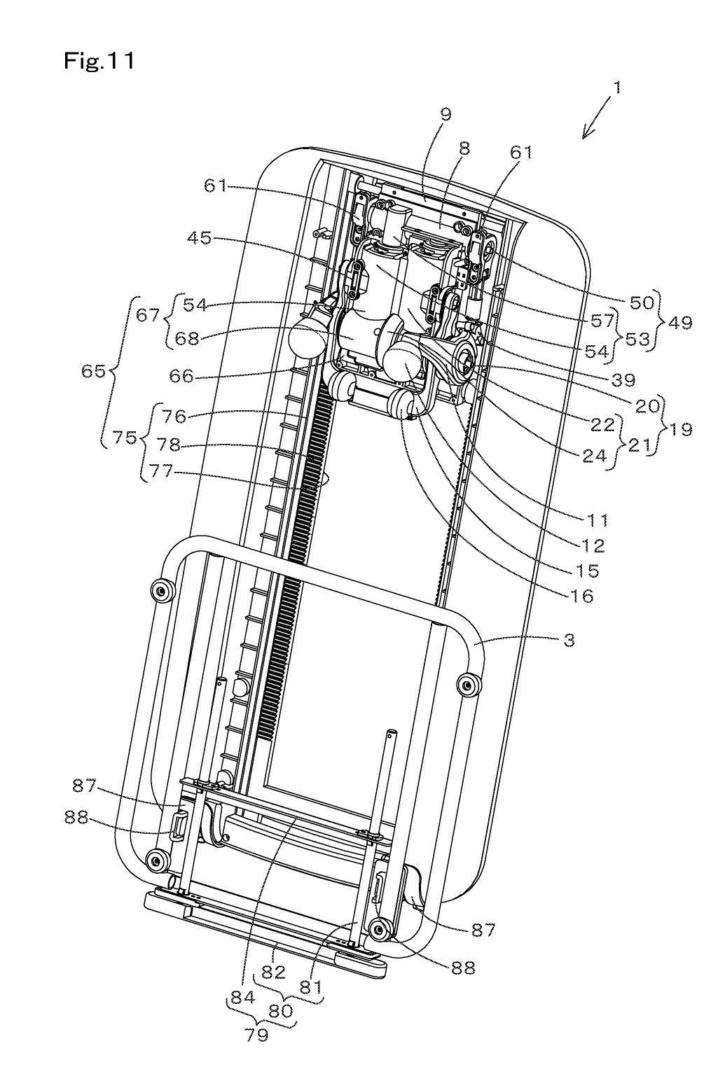

By the way, as shown in FIG. 11, the seat part 2 is foldably configured so as to be overlaid with respect to the backrest part 4.

Specifically, a pair of folding mechanisms 87 are provided in the width (left and right) direction of the legless chair-type massage machine 1 between the rear portion of the seat part 2 and a lower portion of the backrest part 4. Each folding mechanism 87 includes: a protruding piece 88 provided in an upward protruded state in the rear portion of the seat part 2; and a pivotally supporting member (not shown) built in the lower portion of the backrest part 4 for freely swingably pivoting the protruding piece 88.

The protruding piece 88 is a plate piece having a predetermined height in the vertical (longitudinal) direction and having a hole (not shown) formed in the upper portion. The pivotally supporting member is a plate piece long sized in the vertical (longitudinal) direction having a hole formed in the lower portion. The pivotally supporting member pivotally supports the protruding piece 88 upon fitting the hole formed in the lower portion and the hole of the protruding piece 88.

This protruding piece 88 swings upward with respect to the pivotally supporting member, whereby the seat part 2 is folded so as to be overlaid with the backrest part 4 and the thickness in the back and forth direction in the seat chai-type massage machine 1 can be thinned and made compact (see FIG. 11). Further, the protruding piece 88 swings downward with respect to the pivotally supporting member, whereby the seat part 2 is drawn out and it becomes possible for a user to sit on the seat part 2 and lean on the backrest part 4 (see FIG. 1).

The following explains an operation aspect of the massage mechanism 8 of the present embodiment described above.

At a time of using the legless chair-type massage machine 1 having the massage mechanism 8 of the present embodiment built therein, first, it is assumed that the operation is started from a state that the seat part 2 is folded so as to be overlaid on the backrest part 4 as shown in FIG. 11.

As shown in FIGS. 1 and 7, the seat part 2 is drawn out from the folded state to be a horizontal direction and the flame member 3 of the fall prevention member 80 is drawn out rearward from the seat part 2. That is, a user places the legless chair-type massage machine 1 on a floor surface in a state that the backrest part 4 is generally standing. Then, in this placing state, the user sits on the seat part 2.

At this time, the massage mechanism 8 built in the legless chair-type massage machine 1 is positioned in the upper side of the opening portion 7 of the backrest part 4. That is, each of the first treating tips 12 and each of the second treating tips 16 of the massage mechanism 8 are positioned so as to abut to the shoulder region of the user.

There, in the case where a gripping and kneading massage operation is rendered to be performed, upon keeping the massage mechanism 8 in the corresponding position, a power supply is turned on and the gripping and kneading drive motor 22 is driven to thereby swing the first treating tip 12 of the first massage member 11 and the second treating tip 16 of the second massage member 15 via the rotating drive shaft 20. Upon performing this operation, the first treating tip 12 and the second treating tip 16 is operated so as to be brought close to and separated away from the shoulder region of the user to thereby perform a gripping and kneading operation to the shoulder region of the user.

Meanwhile, in the case where the massage mechanism 8 is moved to the back region (shoulder region to lumbar region) of a user, the movement motor 54 (tapping drive motor) is driven to rotate the hoisting and lowering shaft 66 to thereby move the base 9 stopping at the upper portion of the backrest part 4 downward. At the same time of this, since the first treating tip 12 of the first massage member 11 swings back and forth by the tapping drive motor 54 via the rotating drive shaft 50 and the link member 61, the tapping massage can be performed for the user.

In summary, the legless chair-type massage machine 1 including the massage mechanism 8 of the present embodiment is a mechanism capable of optionally selecting two massage operations of the gripping and kneading massage and the tapping massage, and by swinging each of the first treating tips 12 and each of the second treating tips 16 so as to be brought close to and separated away from by the gripping and kneading massage mechanism 19 at the upper end (upper portion of the backrest part 4) of the rail member 75, a gripping and kneading massage effect can be applied to the shoulder region of the user.

In this way, in the case of performing a tapping massage operation, by driving the vertical movement mechanism 65 and moving the massage mechanism 8 in the vertical direction, a tapping massage effect by the tapping massage mechanism 49 can be applied over a vertical range from a shoulder region to a lumbar region (back region) of a user.

Note that, the range of the present invention is not indicated by the explanation described above but indicated by a range of claims and it is intended to include meanings equivalent to the range of claims and all modifications within the range.

In addition, it should be understood that the embodiments disclosed this time are merely exemplified in all points but not restrictive ones. In particular, matters not explicitly disclosed in the embodiments disclosed this time, for example, drive conditions or operating conditions, various kinds of parameters, sizes of components, weights, volumes and the like are not departing from a range for those skilled in the art to normally carry out but values easily anticipated by those skilled in the art are adopted.

### REFERENCE SIGNS LIST

1 . . . Legless chair-type massage machine
2 . . . Seat part
3 . . . Frame member
4 . . . Backrest part
5 . . . Base plate (rear side plate)
6 . . . Coated plate (front side plate)
7 . . . Opening portion
8 . . . Massage mechanism
9 . . . Base
10 . . . Massage body
11 . . . First massage member (upper massage member)
12 . . . First treating tip
13 . . . First annular fitting portion
14 . . . Support portion (middle portion)
15 . . . Second massage member (lower massage member)
16 . . . Second treating tip
17 . . . Second annular fitting portion
18 . . . Support portion
19 . . . Gripping and kneading massage mechanism
20 . . . Rotating drive shaft (for gripping and kneading massage operation)
21 . . . Gripping and kneading drive unit
22. First drive motor (gripping and kneading drive motor)
23 . . . Motor rotating shaft (output shaft)
24 . . . First gear box
25 . . . Rotating shaft
26 . . . Worm gear
27 . . . worm wheel
28 . . . Pinion gear
29 . . . Gear
30 . . . Conversion part
31 . . . Tilt boss part
32 . . . Cam surface
33 . . . Inclined end face
34 . . . Inner cam member
35 . . . Outer cam member
36 . . . Bearing
37 . . . One end face
38 . . . Regulation boss part
39 . . . First regulation part
40 . . . First regulation pin
41 . . . First regulation piece (recess)
42 . . . Eccentric boss part
43 . . . Cam surface
44 . . . Through-hole
45 . . . Second regulation part
46 . . . Second regulation pin
47 . . . Second regulation piece
48 . . . Regulation groove (long hole)
49 . . . Tapping massage mechanism
50 . . . Rotating drive shaft (for tapping massage operation)
51 . . . Eccentric cam member
53 . . . Tapping drive unit
54 . . . Second drive motor (tapping drive motor, movement motor)
55 . . . One output shaft
56 . . . Other output shaft
57 . . . Second gear box
58 . . . Worm gear
59 . . . Worm wheel
60 . . . Bearing
61 . . . Link member
62 . . . Third annular fitting portion
63 . . . Bearing
64 . . . Middle portion
65 . . . Vertical movement mechanism
66 . . . Hoisting and lowering shaft
67 . . . Hoisting and lowering drive unit
68 . . . Third gear box
69 . . . Rotating shaft
70 . . . First worm gear
71 . . . First worm wheel
72 . . . Second worm gear
73 . . . Second worm wheel
74 . . . Pinion gear
75 . . . Rail member
76 . . . Front side wall
77 . . . Rear wall
78 . . . Rack gear
79 . . . Fall prevention mechanism
80 . . . Fall prevention member
81 . . . Bar member
82 . . . Coupling member
83 . . . Through-hole
84 . . . Guide member
85 . . . Hole
86 . . . Through-hole
87 . . . Folding mechanism
88 . . . Protruding piece
89 . . . Support part

1. A massage mechanism comprising:
a first massage member provided on a base and having a first treating tip provided at a distal end for applying a massage operation from above to a treatment region of a user;
a second massage member provided on the base and provided at a position facing the first treating tip, having a second treating tip provided at a distal end for applying a massage operation so as to be brought close to and separated away from the first treating tip;
a rotating drive shaft provided on the base so as to be oriented in a left and right direction and transferring rotating drive power to the first massage member and the second massage member;
a hoisting and lowering shaft provided on the base so as to be oriented in the left and right direction and transferring drive power for moving the base in a vertical direction;
a first drive motor for rotating the rotating drive shaft to drive the first massage member and the second massage member; and
a second drive motor for driving the first massage member while rotating the hoisting and lowering shaft to be moved in the vertical direction on the base, wherein
the first drive motor and the second drive motor are adjacently arranged in the left and right direction, and the motor rotating shaft of the first drive motor and the motor rotating shaft of the second drive motor are provided so as to be oriented in the vertical direction, and wherein
the rotating drive shaft is provided in a front side of the two motor rotating shafts and the hoisting and lowering shaft is provided in a rear side of the two motor rotating shafts.

2. The massage mechanism according to claim 1, wherein the second massage member is provided so that the second treating tip is positioned in a lower side of the rotating drive shaft, and the first drive motor and the second drive motor are provided in an upper side of the rotating drive shaft.

3. The massage mechanism according to claim 2 configured to rotate the rotating drive shaft by the first drive motor and swing the first treating tip provided on the first massage member and the second treating tip provided on the second massage member in a manner of being brought close to and separated away from, thereby allowing to perform a gripping and kneading operation.

4. The massage mechanism according to claim 2, wherein the second drive motor is a double axle motor having two motor rotating shafts extending in the vertical direction, and wherein the massage mechanism is configured to allow the first treating tip provided on the first massage member to perform a tapping operation by rotating power of one of the motor rotating shafts and rotate the hoisting and lowering shaft by rotating power of the other motor rotating shaft so as to be moved in the vertical direction on the base.

5. A legless chair-type massage machine comprising: the massage mechanism as defined in claim 1; a seat part which can be placed on a floor surface and on which buttocks of a user can be seated; and a backrest part which is provided in a rear part of the seat part and which is provided supportably a back region of the user and in which the massage mechanism is built-in, wherein
in a rear part of the seat part, there is provided a fall prevention mechanism for preventing the backrest part from falling down rearward when the user does not seat.

6. The legless chair-type massage machine according to claim 5, wherein the fall prevention mechanism is provided so as to be freely retractably advancable rearward with respect to the seat part.

7. The legless chair-type massage machine according to claim 6, wherein the fall prevention mechanism comprises a fall prevention member formed by bending a bar-shaped member in a U-character shape, and a region corresponding to an opening side of the U-character shape is slidably attached to the seat part.

8. The legless chair-type massage machine according to claim 5, wherein the seat part is configured to be foldable so as to be overlaid with respect to the backrest part.

9. A legless chair-type massage machine comprising: the massage mechanism as defined in claim 2; a seat part which can be placed on a floor surface and on which buttocks of a user can be seated; and a backrest part which is provided in a rear part of the seat part and which is provided supportably a back region of the user and in which the massage mechanism is built-in, wherein
in a rear part of the seat part, there is provided a fall prevention mechanism for preventing the backrest part from falling down rearward when the user does not seat.

10. A legless chair-type massage machine comprising: the massage mechanism as defined in claim 3; a seat part which can be placed on a floor surface and on which buttocks of a user can be seated; and a backrest part which is provided in a rear part of the seat part and which is provided supportably a back region of the user and in which the massage mechanism is built-in, wherein
in a rear part of the seat part, there is provided a fall prevention mechanism for preventing the backrest part from falling down rearward when the user does not seat.

11. A legless chair-type massage machine comprising: the massage mechanism as defined in claim 4; a seat part which can be placed on a floor surface and on which buttocks of a user can be seated; and a backrest part which is provided in a rear part of the seat part and which is provided supportably a back region of the user and in which the massage mechanism is built-in, wherein
in a rear part of the seat part, there is provided a fall prevention mechanism for preventing the backrest part from falling down rearward when the user does not seat.
